(19) United States
(12) Patent Application Publication
(10) Pub. No.: US 2011/0298244 A1
(43) Pub. Date: Dec. 8, 2011

(54) METHOD FOR MANUFACTURING A STRUCTURAL PART FOR A MOTOR VEHICLE AND PART THUS OBTAINED

(75) Inventors: Fernando Ballesteros, Lyon (FR); Denis Gille, Bellignat (FR); Patrick Bosg, St Barthelemy De Vals (FR)

(73) Assignee: COMPAGNIE PLASTIC OMNIUM, Lyon (FR)

(21) Appl. No.: 12/919,848

(22) PCT Filed: Feb. 26, 2009
(86) PCT No.: PCT/FR09/50309

§ 371 Date: Dec. 23, 2010

(30) Foreign Application Priority Data
Feb. 28, 2008 (FR) 0851289

(51) Int. Cl. B62D 25/08; B62D 29/04; B29C 45/16; B29C 45/14

(52) U.S. Cl. 296/193.05; 264/241; 296/187.01

(57) ABSTRACT

The invention relates to a method for manufacturing an overmoulded part that defines a structural part for a motor vehicle, comprising:
a moulding step during which at least one member of the part is moulded from a first material containing a thermosetting material, using a mould shaped so that at least one portion of the member forms a material web,
an overmoulding step during which a second material containing a thermoplastic material is overmoulded on at least one of the material webs of the member so that the material web is torn under the pressure of the second material, a passage for the second material being then formed through the member.

It also concerns a structural part for a motor vehicle.

### CROSS-REFERENCE

The present application is the United States National Stage Entry of International Application Number PCT/FR2009/050309, filed Feb. 26, 2009, and claims priority to French Application Number 0851289, filed Feb. 28, 2008, the entirety of both of which is incorporated herein by reference.

### TECHNICAL FIELD

This application concerns the technical field of manufacture of structural parts for motor vehicles, in particular but not exclusively technical front sides, wing supports and floors.

### BACKGROUND

A metallic profile with a U-shaped cross-section comprising a bottom, two side walls and two edges each connected to a side wall is already known in the state of the art, especially in document EP 0 370 342. Ribs made from plastic material are overmoulded on the profile. The composite part resulting from the overmoulding operation can be used in the motor vehicle field.

The profile is drilled with through holes on its edges. During overmoulding, these through holes form a passage for the plastic material forming the ribs.

To lighten motor vehicles, one trend consists in making motor vehicle structural parts from plastic material. In the above-mentioned composite part, therefore, the drilled metallic profile could be replaced by a profile made from plastic material. However, to obtain a plastic member to be overmoulded drilled with through holes, the plastic member must first be made (for example by extrusion or compression moulding), then punched at the required places so as to form through holes.

### SUMMARY

The aim of the invention is to simplify the method for manufacturing overmoulded parts comprising a plastic member to be overmoulded, while retaining mechanical properties that are satisfactory for the overmoulded part.

The invention therefore relates to a method for manufacturing an overmoulded part that defines a structural part for a motor vehicle, the method comprising:
a moulding step during which at least one member of the part is moulded from a first material containing a thermosetting material, using a mould shaped so that at least one portion of the member forms a material web,
an overmoulding step during which a second material containing a thermoplastic material is overmoulded on at least one of the material webs formed in the member, so that the material web is torn under the pressure of the second material, a passage for the second material being then formed through the member.

Consequently, the method for making the overmoulded part does not require a specific step to form the through holes in the member made from thermosetting material, the passage formed for the thermoplastic material being created during the overmoulding step. The method for manufacturing the overmoulded part is therefore simplified.

In addition, due to the presence of the passage in the thermosetting material, the mechanical adhesion of the thermoplastic material onto the thermosetting material is improved.

The thickness of the material web is preferably less than 1 mm, in particular less than or equal to 0.5 mm, especially between 0.2 mm and 0.5 mm.

The method according to the invention may also comprise any of the characteristics in the following list:
the member is moulded using a mould shaped so that the material web comprises an incipient break zone, preferably a zone of reduced thickness, located in particular on the periphery of the material web. This zone makes it easier to tear the material web which can therefore be torn under more varied overmoulding conditions, especially less dependent on the direction of flow of the material and its injection pressure;
the second material is overmoulded by injection;
the first material is SMC (Sheet Moulding Compound) or AMC (Advanced Moulding Compound);
the second material is polypropylene (PP).

The invention also relates to a structural part for a motor vehicle comprising at least one structural member made from a first material containing thermosetting material, at least one passage being formed in the first member. The passage is filled with a second material containing thermoplastic material, the part also comprising a material web made from the first material and buried in the second material.

Such a part is made using the method described above. Once the material web is torn during the second step, in fact, it is buried in the thermoplastic material.

The structural part may also comprise any of the characteristics in the following list:
the structural member and the material web are connected;
the material web and the structural member form two separate parts connected only by the second material. This case corresponds to that in which the material web has separated from the member in a single piece. This may occur in particular when, before the overmoulding, the material web comprises a fragile zone on its periphery, the same pressure being applied over the entire fragile zone;
the part forms a technical front side for motor vehicle;
the structural member is substantially straight and the part comprises at least one upright substantially perpendicular to the structural member made from the second material;
the part comprises two uprights extending downwards when the technical front side is mounted on a motor vehicle and a lower cross member connecting the two uprights, the uprights and the cross member being made from the second material;
the first material is SMC or AMC and/or the second material is polypropylene;
the part comprises at least one rib covering a passage formed through the structural member, the rib being made from the second material.

The invention also relates to a structural member for a motor vehicle obtained following the moulding step in the manufacturing method according to the invention.

The structural member is more precisely the part obtained following the moulding step in the manufacturing method and before the second material overmoulding step.

### BRIEF DESCRIPTION OF THE DRAWINGS

It will be easier to understand the invention on reading the following description of embodiments, given purely as examples and referring to the drawings, on which:

FIG. 1 represents a structural part according to one embodiment of the invention,

FIG. 2 illustrates a moulding step in a method for making the structural part of FIG. 1;

FIG. 3 represents a structural member of the part of FIG. 1, resulting from the moulding step illustrated on FIG. 2;

FIG. 4 is a transverse cross-section along IV-IV of the structural part of FIG. 1 during an overmoulding step in the method for making this part;

FIG. 5 is a close-up view of an area V of the part of FIG. 1;

FIG. 6 illustrates a moulding step in a method for making a structural part according to another embodiment of the invention,

FIG. 7 is a transverse cross-section of an overmoulded part according to another embodiment of the invention.

### DETAILED DESCRIPTION

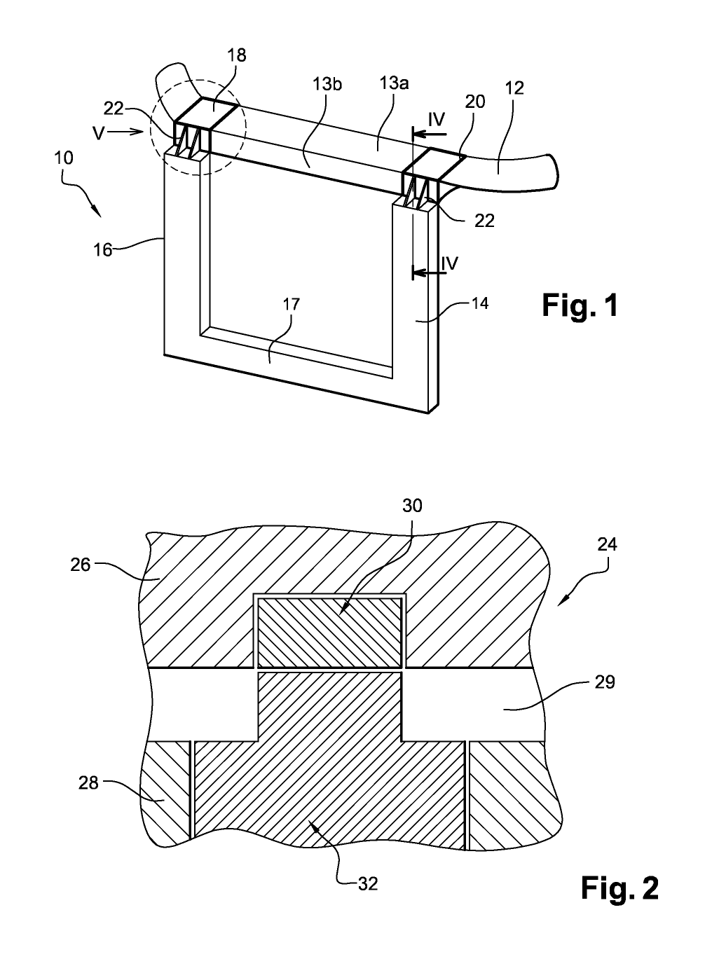

FIG. 1 represents a structural part according to one embodiment of the invention. The part forms a technical front side 10 for a motor vehicle.

The technical front side 10 comprises a cross member 12, called the upper cross member, forming a structural member of the technical front side.

The cross member 12 is made from a first material containing thermosetting material, such as AMC (Advanced Moulding Compound) or SMC (Sheet Moulding Compound). When it is mounted on the vehicle, this cross member is substantially horizontal and of longitudinal dimension extending across the vehicle. This cross-member forms a profile; more precisely a C-shaped profile, comprising two side walls 13a mainly connected by the wall directed towards the front 13b of the cross member. This cross member has a structural function.

The technical front side 10 also comprises two uprights 14 and 16 spaced on the upper cross member 12 and extending, when they are mounted on the vehicle, substantially vertically and downwards, perpendicular to the upper cross member 12. These uprights 14, 16 support functional members of the vehicle such as a headlight unit. They are connected at their lower ends by a cross member 17, called the lower cross member, substantially parallel to the upper cross member 12 and, once the technical front side 10 is mounted on the vehicle, solicited in case of pedestrian impact. The uprights 14, 16 are connected to the upper cross member 12 each in one of its zones 18, 20. They comprise ribs 22, formed near the connection zone 18, 20. The uprights 14, 16 and the lower cross member 17 are made from a second thermoplastic material, such as polypropylene.

A method for manufacturing the technical front side of FIG. 1 will now be described using FIGS. 2 to 5.

The method for manufacturing the technical front side according to FIG. 1 comprises a moulding step, during which the upper cross beam 12 is moulded in the first material, in this case AMC or SMC. The moulding step is carried out using a mould shaped so that at least one portion of the cross member 12 forms a material web.

The thickness of each material web is less than 1 mm, preferably less than or equal to 0.5 mm, especially between 0.2 mm and 0.5 mm.

As shown on FIG. 2, the mould 24 comprises a die 26 and a stamp 28, forming a moulding chamber 29. The mould 24 also comprises a block 30 of dimensions much smaller than those of the mould and placed in the die, and a spindle 32 located opposite the block 30, placed in the stamp. This spindle 32 projects past the stamp 28 and can be used to reduce the thickness of the moulding chamber locally, so as to form during the moulding a material web between the block 30 and the spindle 32.

The block 30 and the spindle 32 added in the mould are used to manage the wear of the mould. Indeed, at the material web, a fibre-reinforced moulding compound such as AMC or SMC tends to comprise a locally greater percentage of fibres since it is thinner. At the material web, the mould wears more quickly than in the areas used to mould the rest of the part. By planning a removable block 30 and spindle 32, the members used to form this area of the mould can be changed relatively often so as to obtain a material web of the required thickness, without having to change the entire mould which increases the manufacturing costs of the part.

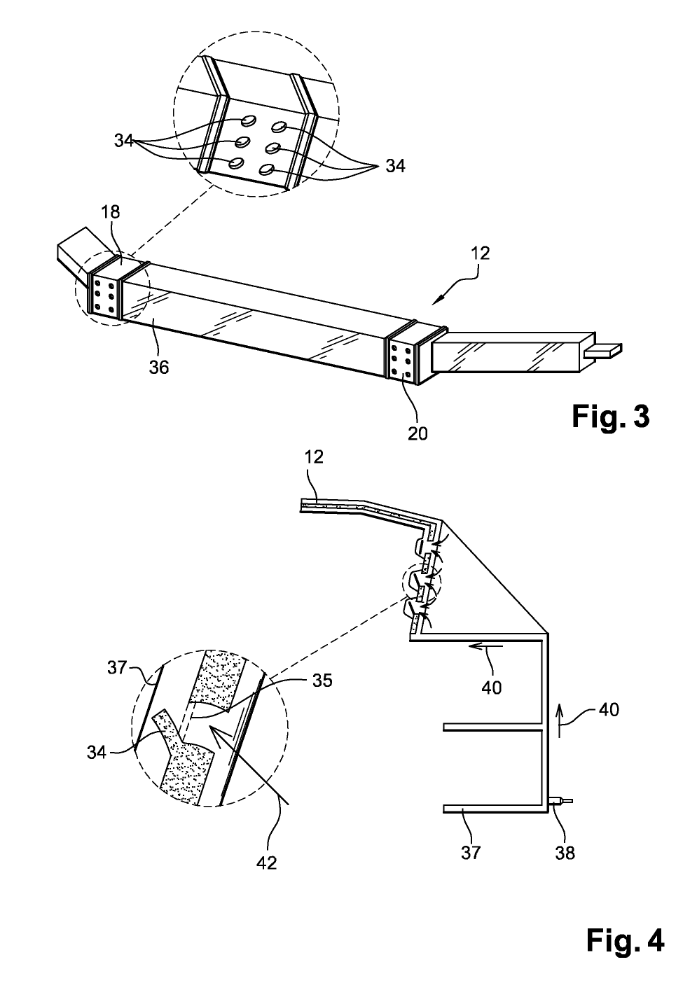

Following the moulding step described above, a structural member intended to form the upper cross member 12 of the technical front side is obtained, as shown on FIG. 3. In two zones corresponding to zones 18, 20 for connection with the uprights of the technical front side, this member comprises a plurality of portions forming a material web 34. Six material webs are formed in each zone 18, 20 of the structural member. The portions forming material webs 34 are designed so as to form, when the cross member is mounted on the motor vehicle, two substantially vertical rows of three material webs. Each material web has a substantially oblong shape.

The material webs are recessed with respect to the front side 13b of the part, the part forming in these portions a well opening onto side 13b whose bottom is the material web 34.

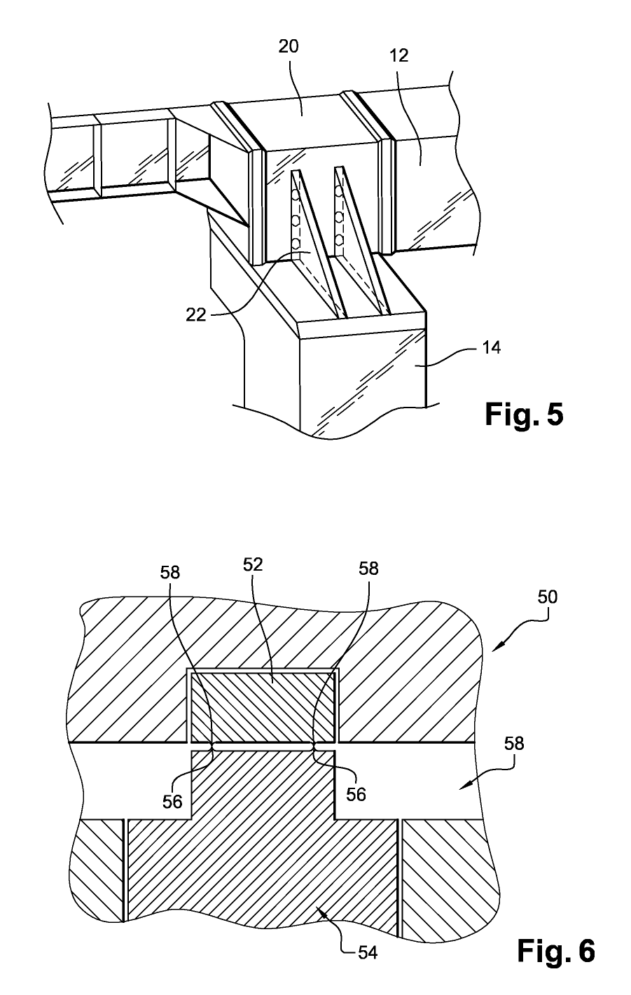

Once the structural member has been shaped, the method for manufacturing the technical front side comprises an overmoulding step, shown on FIG. 4, during which a second material containing plastic material, in this case polypropylene, is overmoulded by injection onto the structural member intended to form the cross member 12, to form the uprights 14, 16 and the lower cross member 17. The mould used to form the uprights 14,16 and the lower cross member 17 comprises a moulding chamber which closes to cover each of zones 18 and 20, comprising the material webs.

As shown on FIG. 4, the cross member 12 is placed in a mould and polypropylene is injected through an injection point 38, on one side only of the structural member. The polypropylene injected under pressure flows in the mould in the direction indicated by the arrows 40. When it reaches one of the zones forming a material web 34, the web, which was initially in the position represented in dotted lines on the detail of FIG. 4, tears, due to the pressure of the polypropylene which has built up on the material web and indicated by the arrows 42 and due to the fact that the material web is thin. The polypropylene 37 can then fill the passage left free by the tearing of the material web 34 and also stick on the back of the structural member.

The material web 34 is then buried in the polypropylene 37 and is connected to the rest of the cross member such that it would be able to rotate around an axis of the cross member 12 without the presence of the polypropylene 37.

As shown on FIGS. 4 and 5, each upright 14 is overmoulded in the zone 20 of the upper cross member 12, such that it comprises two ribs 22. Each of these ribs covers the passage formed by the tearing of the material webs 34 in the upper cross member 12.

The invention is not limited to the previously described embodiment.

As shown on FIG. 6, to make the material web even easier to break, a mould 50 used to perform the moulding step can be shaped such that the material web comprises a zone of reduced thickness forming an incipient break zone for this material. This zone is located on the periphery of the material web. The added block 52 and the added spindle 54 used to form the material web each comprise an indentation, respectively 56, 58, projecting out from the surface of the block 52 or of the spindle 54 forming the rest of the material web. The indentations 56, 58 are located opposite each other, reducing the thickness of the material web around its periphery.

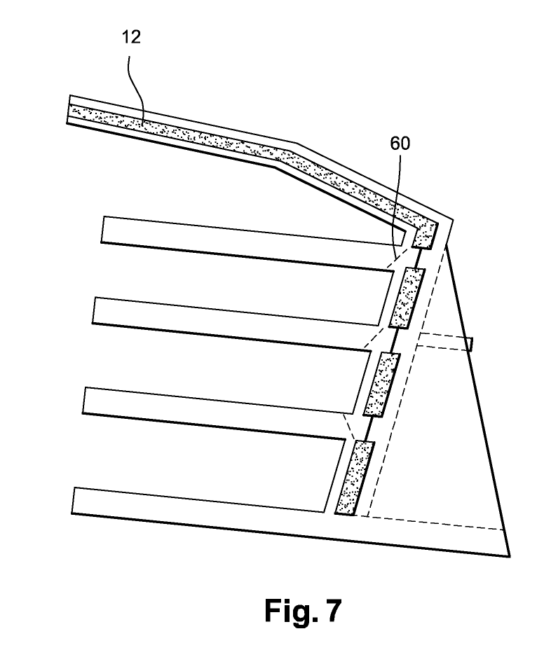

In addition, as also shown on FIG. 7, the shape of the overmoulded part may vary even if it is made using the same cross member 12.

In addition, as shown on FIG. 7, after the overmoulding step, a material web 60 can be detached from the rest of the cross member 12 and form a separate member of this cross member 12, being connected only to this cross member by the second overmoulded material, for example polypropylene.

Note also that the thermoplastic material can be injected in various ways during the overmoulding steps. The flow of material may in particular be parallel or perpendicular to a direction normal to the material web. In addition, injection may also be carried out from one or both sides. When the part is not symmetrical, in fact, the material injected under pressure does not reach both sides of the material web at the same time and, since the pressure is applied from one side of the web, there is a pressure difference between the opposite sides of the web, which allows the web to tear even if injection is carried out on both sides of the part.

Note also that the materials and shapes of the various members of the front side are not limited to those described.

The structural part may also be a type of structural part for motor vehicles other than that described, such as a wing support or floor for motor vehicles.

1. Method for manufacturing an overmoulded part that defines a structural part for a motor vehicle, comprising:
a moulding step during which at least one member of the part is moulded from a first material containing a thermosetting material, using a mould shaped so that at least one portion of the member forms a material web
an overmoulding step during which a second material containing a thermoplastic material is overmoulded on at least one of the material webs of the member so that the material web is torn under the pressure of the second material, a passage for the second material being then formed through the member.

2. The method according to claim 1, wherein the member is moulded using a mould shaped so that the material web comprises an incipient break zone, preferably a zone of reduced thickness, located in particular on the periphery of the material web.

3. The method according to claim 1, wherein the first material is SMC (Sheet Moulding Compound) or AMC (Advanced Moulding Compound).

4. The method according to claim 1, wherein the second material is polypropylene (PP).

5. The method according to claim 1, wherein the second material is overmoulded by injection.

6. Structural part for a motor vehicle, comprising at least one structural member made from a first material containing a thermosetting material, at least one passage being formed in the first member, the passage being filled with a second material, containing thermoplastic material, the part also comprising a material web made from the first material and buried in the second material.

7. The part according to claim 6, wherein the structural member and the material web are connected.

8. The part according to claim 6, wherein the material web and the structural member form two separate parts, connected only by the second material.

9. The part according to claim 6, forming a technical front side for a motor vehicle.

10. The part according to claim 9, wherein the structural member forms at least one so-called upper cross member and at least one vertical upright when the technical front side is mounted on a motor vehicle, at least one of the uprights being made from the second material.

11. The part according to claim 10, comprising two uprights extending downwards when the technical front side is mounted on a motor vehicle and a lower cross member connecting the two uprights, made from the second material.

12. The part according to claim 6, wherein the first material is SMC (Sheet Moulding Compound) or AMC (Advanced Moulding Compound) and/or the second material is polypropylene (PP).

13. The part according to claim 6, comprising at least one rib covering at least one passage formed through the structural member and made from the second material.

14. Structural member for a motor vehicle, characterised in that it is obtained following the moulding step in the manufacturing method according to claim 1.

15. The method according to claim 1, wherein the member is moulded using a mould shaped so that the material web comprises an incipient break zone, preferably a zone of reduced thickness, located in particular on the periphery of the material web, and wherein the first material is SMC (Sheet Moulding Compound) or AMC (Advanced Moulding Compound) and the second material is polypropylene (PP).

16. Structural member for a motor vehicle, characterised in that it is obtained following the moulding step in the manufacturing method according to claim 15.

17. The part according to claim 6, forming a technical front side for a motor vehicle and wherein the structural member forms at least one so-called upper cross member and two vertical uprights when the technical front side is mounted on a motor vehicle, at least one of the uprights being made from the second material, said two uprights extending downwards when the technical front side is mounted on a motor vehicle, said technical front side comprising a lower cross member connecting the two uprights, made from the second material.
